(19) United States
(12) Patent Application Publication
(10) Pub. No.: US 2013/0202813 A1
(43) Pub. Date: Aug. 8, 2013

(54) PROCESS OF PREPARING GRAPHENE BY LOW-FREQUENCY ELECTROMAGNETIC WAVE

(71) Applicant: National Tsing Hua University, Hsinchu (TW)

(72) Inventors: Yu-Lun CHUEH, Hsinchu (TW); Wen-Chun YEN, Hsinchu (TW); Hung-Chiao LIN, Hsinchu (TW)

(73) Assignee: NATIONAL TSING HUA UNIVERSITY, Hsinchu (TW)

(21) Appl. No.: 13/692,783

(22) Filed: Dec. 3, 2012

(30) Foreign Application Priority Data
Feb. 8, 2012 (TW) 101104065

(51) Int. Cl. C01B 31/04

(52) U.S. Cl. CPC C01B 31/0446; Y10S 977/844; B82Y 40/00
USPC 427/557; 205/194; 977/844

(57) ABSTRACT

The present invention relates to a process of inducing grapheme by low-frequency electromagnetic wave, which includes the following steps: (A) providing a substrate; (B) optionally forming a metal layer on the substrate; (C) providing a carbon source to form a carbon-containing layer locating on the metal layer; and (D) performing a treatment of the carbon-containing layer formed on the metal layer by using low-frequency electromagnetic wave, wherein the low-frequency electromagnetic wave is provided by microwave device. The electromagnetic energy from the microwave field device is converted to thermal energy by microwave absorber (for example, SiC) as a media to directly heat the carbon-containing layer, so that carbon atoms get kinetic energy to form grapheme layers on the surface of the metal layer and between the metal layer and the substrate.

### CROSS REFERENCE TO RELATED APPLICATION

This application claims the benefits of the Taiwan Patent Application Serial Number 101104065, filed on Feb. 8, 2012, the subject matter of which is incorporated herein by reference.

### BACKGROUND OF THE INVENTION

1. Field of the Invention

The present invention relates to a process of producing graphene, and more particularly, to produce graphene by low-frequency electromagnetic wave.

2. Description of Related Art

Graphene is a two-dimensional material formed by carbon atoms. Those sp²-bonded carbon-atoms are linked into six-membered rings, which extends into a two-dimensional planar. Due to the unique two-dimensional structure, carrier such as electrons or holes in graphene can transport at an extremely high speed to make excellent electrical and thermal conduction. Moreover, because the bonding between carbon atoms is extremely strong, as a result graphene has excellent mechanical properties that can be applied to be used in flexible units. In addition, graphene has stable chemical properties and high tolerance to the environment, elements made by graphene are also has excellent stability.

There are many ways to synthesize graphene, such as epitaxial growth by using SiC or Ru, or reducing graphene oxide by oxidation-reduction reaction. To date, the mainstream method to obtain graphene is growing graphene films on a transitional metal substrate (for example, copper or nickel) by chemical vapor deposition (CVD), and the carbon source comes from various carbon-containing gases, like methane or ethylene.

However, the methods described above have some drawbacks, for example, (1) the high temperature furnace tube used in CVD cannot withstand rapid temperature changes, which may cause a limitation on the whole procedure of heating and cooling process, resulting in long manufacturing process; (2) high consumption rate, the whole system is susceptible to heating while the furnace tubes are heating products, such operation could lead to unnecessary energy consumption; (3) difficulty in carbon source control, the CVD method works to get its carbon source from gasses such as methane or ethylene, which then undergoes high temperature pyrolysis to derive carbon atoms, but there is a good possibility for the gases to form vortexes of different sizes in different locations, this could increase unprocessibility in the manufacturing processes; (4) difficulty in cooling rate control, since the entire system is subject to heating, a great deal of thermal energy is stored due to the large heat capacitance of the system, this could lead to a requirement for removal of a great amount of thermal energy during the cooling process, and this could mean difficulty in attempting to achieve rapid cooling rate; and (5) low temperature maneuverability, due to the high storage of thermal energy inside the system, changing system's temperature would not be an easy task to handle, and could mean difficulty in handling the system using complex temperature curves. In view of the above, the aforementioned drawbacks could present to be obstacles to mass production for industrial graphene.

Therefore, it is necessary to provide an improved method to produce graphene to meet the demand for short process time, low energy consumption, easily controlled carbon sources, rapid cooling, and high operational stability. The demanded method may further lower the production cost for large-scale graphene production.

### SUMMARY OF THE INVENTION

An object of the present invention is to provide a graphene production method. This method has advantages including short processing time, low energy consumption, and easy-to-control processing temperature, and can be promising alternative to conventional chemical vapor deposition method for producing graphene. In addition, the method of the present invention can also offer possibility for large production of graphene in a cost-effective way.

To achieve the above object, the process of the present invention includes the following steps: (A) providing a substrate; (B) optionally forming a metal layer on the substrate; (C) providing a carbon source to form a carbon-containing layer on the metal layer; and (D) performing a treatment of the carbon-containing layer formed on the metal layer by using low-frequency electromagnetic wave.

The electromagnetic energy from the microwave field device is converted to thermal energy by a microwave absorber (for example, SiC). As a media, the microwave absorber directly heats the carbon-containing layer to make carbon atoms receive kinetic energy and form graphene layers. Graphene layers form on the surface of the metal layer and between the metal layer and the substrate, which can be categorized into forward graphene and backward graphene.

Generally, a major media for forming a microwave field is electromagnetic wave, therefore, transfer of electromagnetic energy to a target could be rapid. Further, the microwave field can be controlled within a specific space without covering other materials, thus directly heats a target to achieve an ideal temperature. In addition, because it is unnecessary to heat the device directly, unnecessary energy consumption could therefore be decreased. As a result, in comparison with the conventional high temperature furnace tubes, there would be no need to consider equipment in the microwave production process, therefore the total heat capacity is far smaller than conventional high temperature furnace tubes heating system.

In addition, as described above, the whole system can change temperatures quickly because the total heat capacity requirement to increase the temperature is small. The conventional high temperature furnace tubes heating system is unable to directly control cooling process and thermal energy is largely retained in the system that cannot be removed, instead, in the microwave system, thermal energy is dissipated rapidly as soon as the microwave supplier is turned off and when the microwave field collapses. Furthermore, the microwave's output power can be changed to meet a required temperature curve. As a result, the present invention of graphene production method can achieve the requirement of short process time, low energy consumption, and easy-to-control processing temperature.

Of the graphene production method of the present invention, the microwave field device comprises a microwave generator to generate microwave, an isolator for permitting one-way transmission of the microwave, a tuner that is used to adjust frequency of the microwave, a wave guide for transmitting the microwave, and a reacting chamber. Wherein the reaction chamber may be of an elliptic shape with two focuses, which are microwave-dispersing focus and microwave-gathering focus, furthermore, the tuner may transfer microwaves to the reacting chamber.

In the present invention of the graphene production method, a substrate can be selected from plastic, glass, quartz, silicon, metal, and ceramics, where silicon oxide is preferred.

In the present invention of the graphene production method, the step (B) may be omitted if the substrate is a metal substrate, this means that the metal sheet or metal plate for use as catalytic metal layer can be used directly as a substrate, so that a carbon-containing layer may form on the metal substrate without plating another metal layer, and then follows a graphene growing process.

In addition, in the present invention of graphene production method, the metal layer in the step (B) may be formed by evaporation, sputtering, electroplating, or electroless (oxidation-reduction method) plating, wherein evaporation and sputtering are preferred. Further, the metal layer in the step (B) may be made of nickel, copper, nail, iron, gold, or an alloy thereof, wherein nickel and copper are preferred. The metal layer in the step (B) has a thickness from 20 nm to 25 μm, and better is 50 nm to 300 nm. When the thickness is thinner than 20 nm, the metal layer has poor stability and is easy to form a separate Metal Island during the manufacturing process; in contrast, when the thickness is more than 25 μm, a separation distance is too long and a solid solubility of the carbon-containing layer is too large, which made carbon atoms seldom reach the surface but being captured inside the metal layer.

In the present invention of graphene production method, a carbon-containing layer on the metal substrate in the step (C) is formed by evaporation, sputtering, or coating, where sputtering is preferred. Carbon sources in the step (C) may be ordered carbon or carbon-based polymer, such as polymethylmethacrylate (PMMA), polydimethylsiloxane (PDMS), polycarbonate (PC), or polyethylene terephthalate (PET), etc, for which a solid state, liquid state, or gas state of carbon source can all be used. Furthermore, the thickness of the carbon-containing layer may be 5 nm to 100 nm, where 5 nm to 20 nm is preferred. The thickness layer thinner than 5 nm has poor continuation of formed carbon films and may not obtain continuous thin films in large area, however, when the thickness of the carbon-containing layer is more than 100 nm, there is too much carbon and can make it difficult for the carbon films to be fused into metal layer, and the remaining part of it will remain on the surface to form protrusions Further, because the carbon-containing layer in the system is solid, it is much more easier to control the process without worrying about vortex effect caused by fluid mechanics hydrodynamics.

In the present invention of graphene production method, the low-frequency electromagnetic wave in the step (D) may be in single-frequency mode or multi-frequency mode. Wherein the low-frequency electromagnetic wave in the single-frequency mode may have a frequency of 945 or 2450 MHz, while in the multi-frequency mode the frequency may be 945±50 or 2450±50 MHz. In addition, the power of the low-frequency electromagnetic wave may be from 200 W to 1200 W, and 700 W is preferred. When the power of the low-frequency electromagnetic wave is smaller than 200 W, carbon atom may not have enough energy to leave an origin position and diffuse into the metal substrate, however, when the power of the electromagnetic wave is higher than 1200 W, carbon atom will tend to disperse from surface due to the carbon atom receiving excessive energy.

In addition, in the present invention of graphene production method, the electromagnetic wave provides a heat treatment temperature from 300° C. to 1200° C. in the step (D), wherein 750° C. is preferred. When the heat treatment temperature is lower than 300° C., a carbon atom may not leave its origin position to enter the metal substrate, in contrast, as the temperature is higher than 1200° C., metal particles will disappear because of evaporation.

In another aspect of the present invention of the graphene production method, there further comprises a step (E) after the step (D), for turning off the microwave field device for cooling and turning on the microwave field device again, wherein the step (E) is repeated more times to form multiple graphene layers. By warming and cooling the system via turning on/off the microwave device described above to grow graphene layer by layer, a high quality and large-area graphene could be obtained, therefore reducing occurrence of degraded graphene products, and producing graphene layers based on a practical application of requirement. In addition, in the present invention of graphene production method, the backward graphene's thickness may be 2 nm to 50 nm, and the forward graphene's thickness may be 1 nm to 5 nm, both of the two graphene layers may change layer numbers by adjusting parameters, however, there is no limitation on the layer numbers in the present invention.

The main aspect of the present invention is to produce a suitable size of microwave field in the reaction chamber of microwave device, by using the microwave absorber as a media to convert the electromagnetic energy into thermal energy to heat test samples directly, so that the carbon atoms receive enough kinetic energy to form mono-, double-, or multiple graphene films on the substrate surface.

### BRIEF DESCRIPTION OF THE DRAWINGS

FIGS. 1A-1E are sectional schematics of the preparation process flow;

FIG. 2 is a schematic of the microwave field devices;

FIG. 3A is an exploded schematic of the backward and forward graphene layers;

FIG. 3B is a sectional (A region of FIG. 3A) enlargement structure schematic of backward graphene layer;

FIG. 4 is a Raman spectrum of forward graphene prepared by use of different power of microwaves;

FIG. 5 is a Raman spectrum of forward graphene prepared by use of different thickness of carbon-containing layer.

FIG. 6 is a Raman spectrograph of different metal layer thickness.

FIG. 7 is a Raman spectrum of tolerance examinations of obtained graphemes re-treat microwaves with different powers.

### DETAILED DESCRIPTION OF THE PREFERRED EMBODIMENT

Exemplary embodiments of the present invention will be described in detail with reference to the accompanying drawings. People who are familiar with this technology may easily understand the advantage and other aspects by the present invention. It should be noted that the scope of the present invention is not limited by the illustrated embodiments, the invention may be practiced otherwise than as specifically described within the scope of the appended claims.

### Embodiment 1

### Preparation of Graphene Layers

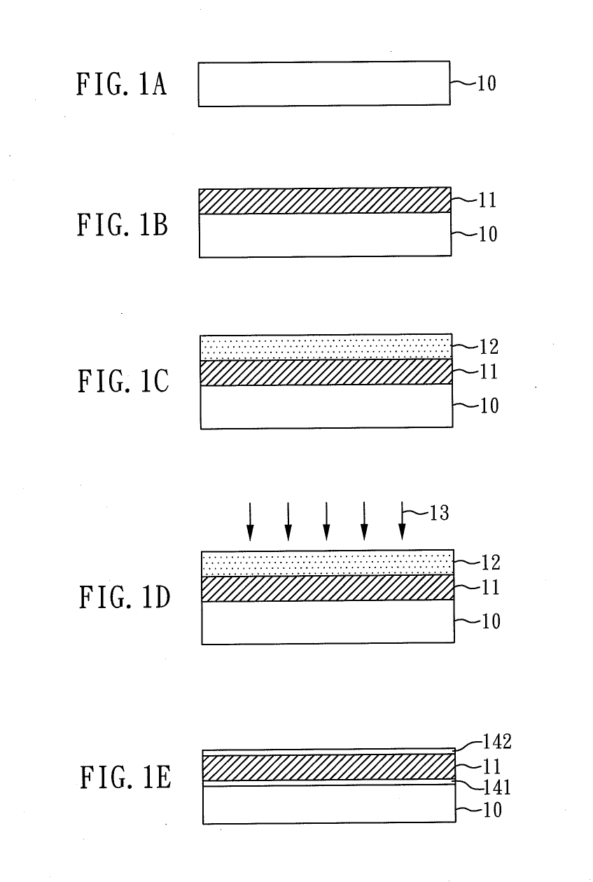

First, referring to FIG. 1A, there is provided a substrate 10, and then a metal layer 11 is evaporated onto the substrate 10 (see FIG. 1B), wherein the substrate 10 is made of silicon oxide and the metal layer 11 is made of nickel which has a thickness of 50 nm in this embodiment. In addition, the conditions of a metal layer-forming evaporation procedure, comprising: 5×10⁻⁶ torr degree of vacuum, and the evaporation rate is 0.3-1 Å/s.

Next, referring now to FIG. 1C, a carbon-containing layer 12 is formed on the metal layer 11. In this embodiment, a disordered carbon is used as carbon source, and then deposited by electron beam evaporation method to form the carbon-containing layer 12 on the metal layer 11, and the carbon-containing layer 12 has a thickness about 20 nm. Further, the conditions of the carbon-containing layer procedure, comprising: 5×10⁻⁶ torr degree of vacuum, and the evaporation rate is 0.3-1 Å/s. Now the silicon oxide substrate/nickel layer/disorder carbon sample is formed to grow graphene.

Second, as shown in FIG. 1D, a carbon-containing layer 12 of a metal layer 11 treated by low frequency electromagnetic wave 13 is provided, wherein a microwave generator provides the low-frequency electromagnetic wave 13, and converts electromagnetic energy into thermal energy through microwave absorbers (SiC) as media to directly heat the carbon-containing layer 12. Carbon atoms of the carbon-containing layers 12 receive kinetic energy to diffuse and enter into the nickel metal substrate. During the cooling process, graphene layers form on a surface of the metal layer 11 and between the metal layer 11 and the substrate 10, which are forward graphene layer 142 and backward graphene layer 141. In addition, in the embodiment, the low-frequency electromagnetic wave 40 is a multi-frequency wave having a frequency of 2450(±50) MHz, a power of 600 W, and a heat treatment temperature of 750-850° C.

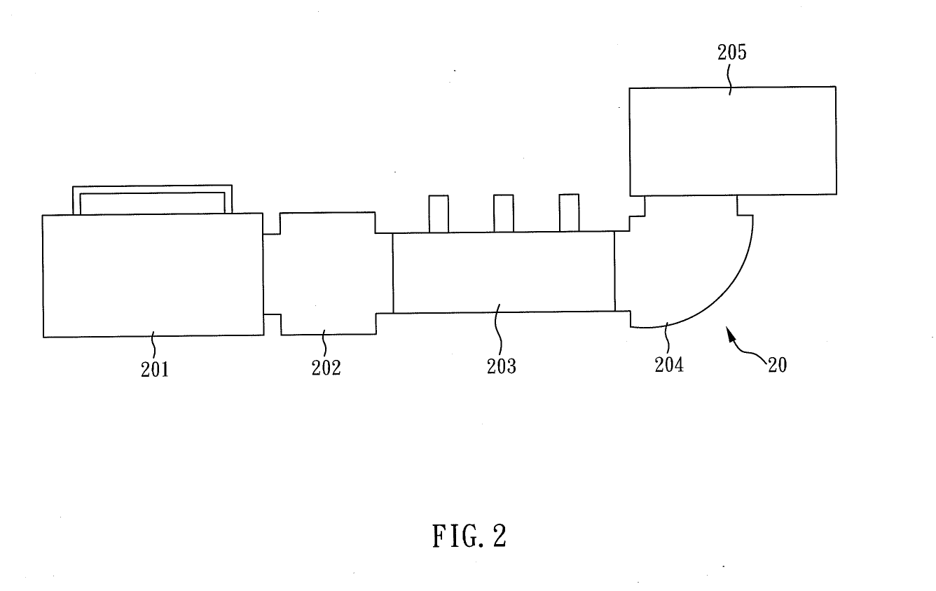

Referring to FIG. 2, a schematic of microwave generator is provided. The microwave field device 20 comprises a microwave generator 201 to generate microwave; an isolator 202 for permitting single direction transmission of the microwave without reflection, serving as a protective device; a tuner 203 that is used to adjust frequency to achieve the maximum power application; a wave guide 204 for transmitting the microwave; and a reacting chamber 205. The reaction chamber 205 may be of an elliptic shape with two focuses, which are microwave-dispersing focus and microwave-gathering focus, furthermore, the tuner 204 may transfer microwaves to the reacting chamber 205.

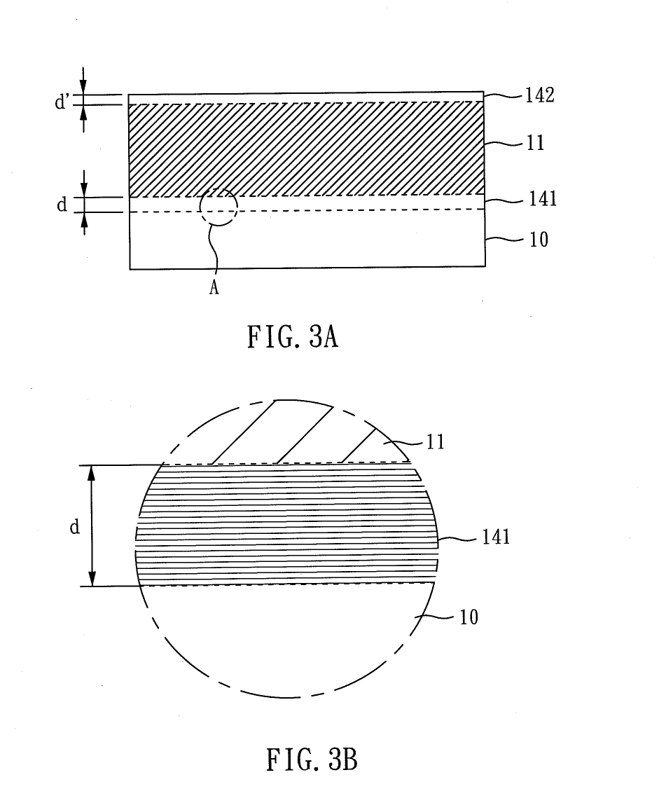

Another embodiment of producing graphene layers further comprises a step, which is to heat the test sample by microwave and to form graphene layers on two sides of metal layer 12. Then, for the microwave generator 20 is turned off for cooling and the microwave generator is turned on again to form the second layer of graphene. The steps mentioned above are repeated to obtain multiple graphene layers. As shown in. FIG. 3A, the backward graphene layer 141 has a thickness, d, of 2 to 50 nm, and the forward graphene layer 142 has a thickness d′ of 1 to 5 nm, furthermore, FIG. 3B is an enlarged view of A area of FIG. 3A, the forward graphene layer 141 reveals laminated structure, which are multiple graphene layers. The backward graphene layer may have up to 43 layers in this embodiment.

Silicon substrate is used as a substrate, nickel as the material of metal layer, and polymethylmethacrylate (PMMA) as the carbon-containing layer in the embodiment above. However, depending on actual demand, the substrate material may also be selected from plastic, glass, quartz, metal, or ceramics; copper, nail, nickel, gold, iron or an alloy thereof may be the materials of metal layer; ordered carbon, disorder carbon, or carbon polymer may be used as a material of carbon-containing layer.

There are no material limitations for each layer in the present invention, instead, other known materials may be used in substrate, metal layer, and carbon-containing layer are included in this invention. In addition, the metal layer is deposited on the substrate by evaporation in the present invention; however, it may also deposit on the substrate by sputting, electroplating, or electroless plating (oxidation-reduction reaction) depending on actual practice. Moreover, the carbon-containing layer is deposited on metal layer in the embodiment through evaporation, but the sputtering or coating method may also be used in the present invention.

In addition, according to the embodiment procedure above, a Raman spectroscopy technique is used to perform test experiments to focus on the formed graphenes by different process parameters:

[Test 1]

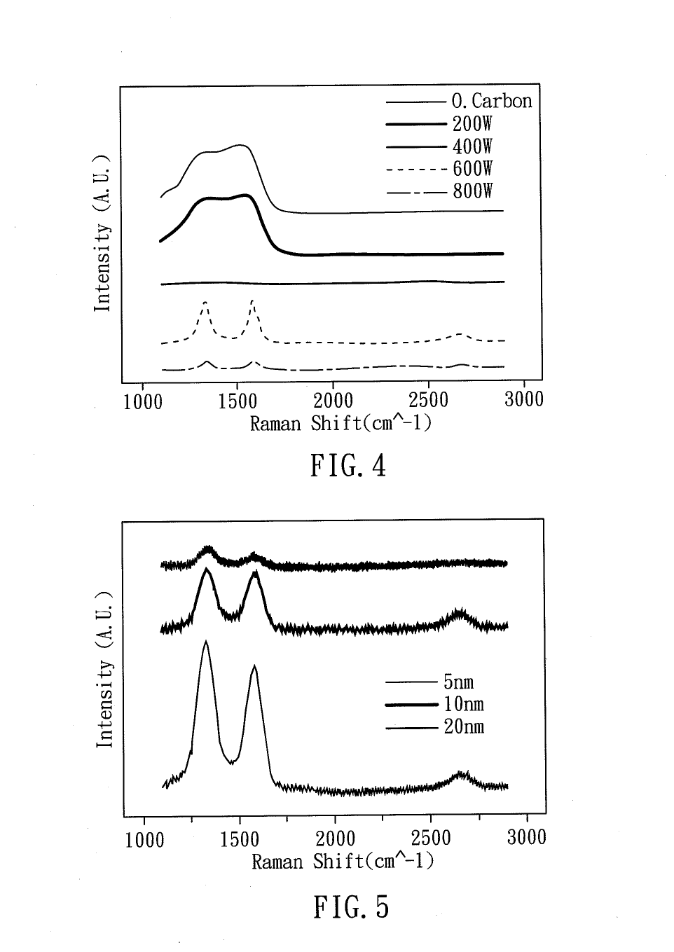

Referring now to FIG. 4, a Raman spectrum of obtained forward graphene by different power of microwaves is shown. There is only amorphous carbon (about 1200-1800 cm⁻¹) revealing in Raman spectrum at 200 W without microwave treatment, which suggests that an energy conversion from heat to kinetic is not enough to form graphene. When the power is 400 W, amorphous carbon disappeared because carbon atoms consumed by atmospheric oxygen once they enter the metal substrate, indicating the kinetic energy is not yet enough. When the power is 600 W, the characteristics of graphene peaks shown in Raman spectrum are D⁻ band (about 1360 cm⁻1), G⁻ band (about 1580 cm⁻1), and 2D⁻ band (about 2700 cm⁻1) to confirm the presence of graphene; however, when the power is 800 W, the carbon diffusion rate is too fast, and causes left metal layer surface erodes to oxidation layer by atmospheric oxygen, which obstruct carbon atom to separate out and thus relatively decrease the peak.

[Test 2]

In reference to FIG. 5, a Raman spectrum of obtained forward graphene by different thickness of carbon layers is shown. According to the figure, the graphene characteristic peaks in Raman spectrum are D⁻ band (about 1360 cm⁻1), G⁻ band (about 1580 cm⁻1), and 2D⁻ band (about 2700 cm⁻1) become more obvious along with the carbon-containing layer is getting thicker, suggesting that more graphene separate out of thicker carbon-containing layer under same thickness metal layers.

[Test 3]

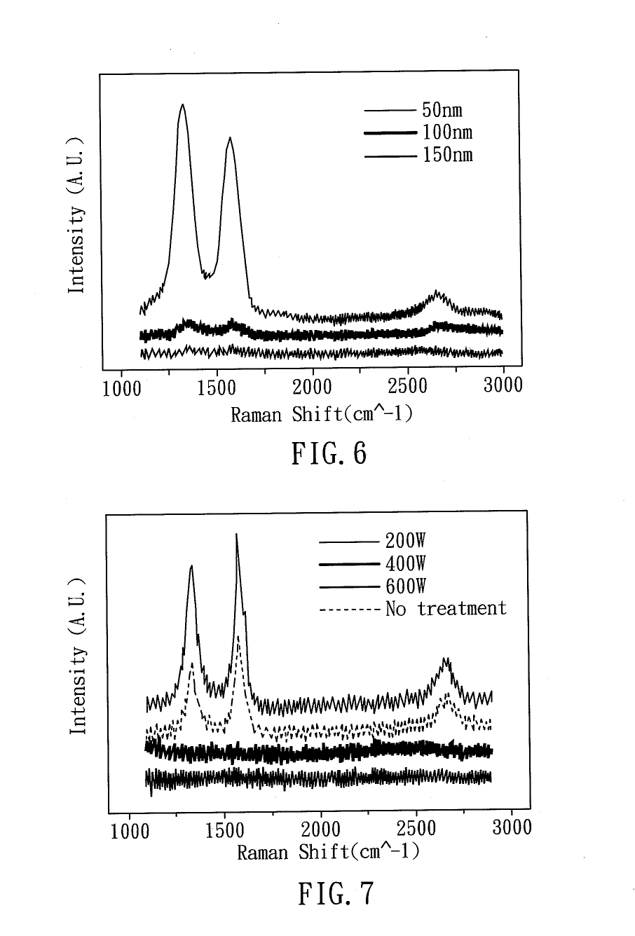

Referring now to FIG. 6, a Raman spectrograph of obtained graphene by different thickness of metal layers is shown. Under the same thickness of the carbon-containing layers, the soluble carbons increase if the metal layer become thicker, thus the separated carbons will relatively decrease.

[Test 4]

Referring to FIG. 7, the tolerances that re-treat the obtained graphenes by microwaves with different powers and measure by Raman spectroscopy is determined. According to the figure, the graphene formed by the present method can stand for 200 W output power treatment, but will be crashed when the power is higher than 400 W.

Although the present invention has been explained in relation to its preferred embodiment, it is to be understood that many other possible modifications and variations can be made without departing from the spirit and scope of the invention as hereinafter claimed.

What is claimed is:

1. A method of producing graphene, comprising:
(A) providing a substrate;
(B) optionally forming a metal layer on the substrate;
(C) providing a carbon source to form a carbon-containing layer on the metal layer; and
(D) performing a treatment on the carbon-containing layer on the metal layer by using low-frequency electromagnetic wave to form graphene layers on a surface of the metal layer and between the metal layer and the substrate, wherein the low frequency electromagnetic wave is provided by a microwave generator, and the graphene layers are formed from carbon atoms of the carbon-containing layer to receive kinetic energy by converting electromagnetic energy from the microwave field device into thermal energy through a microwave absorber as a media to directly heat the carbon-containing layer.

2. The method of claim 1, wherein the microwave field device comprises a microwave generator to generate microwave, an isolator for permitting one-way transmission of the microwave, a tuner that is used to adjust frequency of the microwave, a wave guide for transmitting the microwave, and a reacting chamber.

3. The method of claim 1, wherein the substrate is made of a material selected from the group consisting of plastic, glass, quartz, silicon, metal, and ceramics.

4. The method of claim 1, wherein the step (B) is omitted if the substrate is a metal substrate.

5. The method of claim 1, wherein the metal layer in the step (B) is formed by evaporation, sputtering, electroplating, or electroless plating.

6. The method of claim 1, wherein the metal layer in the step (B) is made of nickel, copper, nail, iron, gold, or an alloy thereof.

7. The method of claim 1, wherein the metal layer in the step (B) has a thickness from 20 nm to 25 μm.

8. The method of claim 1, wherein the carbon-containing layer in the step (C) is formed by evaporation, sputtering, or coating.

9. The method of claim 1, wherein the carbon source in the step (C) is ordered carbon, disordered carbon, or carbon-based polymer.

10. The method of claim 1, wherein the carbon-containing layer in the step (C) has a thickness from 5 nm to 100 nm.

11. The method of claim 1, wherein the low-frequency electromagnetic wave in the step (D) is in single-frequency mode or multi-frequency mode.

12. The method of claim 11, wherein the low-frequency electromagnetic wave in the single-frequency mode has a frequency of 945 MHz or 2450 MHz.

13. The method of claim 11, wherein the multi-frequency mode of the low-frequency electromagnetic wave in the multi-frequency mode has a frequency of 945±50 MHz or 2450±50 MHz.

14. The method of claim 1, wherein the low-frequency electromagnetic wave in the step (D) has a power of from 200 W to 1200 W.

15. The method of claim 1, wherein the heat treatment temperature of the low-frequency electromagnetic wave in the step (D) is 300° C.-1200° C.

16. The method of claim 1, further comprising a step (E) after the step (D), which involves turning off the microwave field device for cooling and turning on the microwave field device again, wherein the step (E) is performed one or more times to form a second graphene layer or multiple graphene layers.
